(19) United States
(12) Patent Application Publication
(10) Pub. No.: US 2016/0297235 A1
(43) Pub. Date: Oct. 13, 2016

(54) Container Assembly

(71) Applicant: Randy Nelson, Brainerd, MN (US)

(72) Inventor: Randy Nelson, Brainerd, MN (US)

(21) Appl. No.: 14/683,815

(22) Filed: Apr. 10, 2015

(51) Int. Cl. B44D 3/12

(52) U.S. Cl. CPC B44D 3/125

(57) ABSTRACT

A container assembly includes a container that may be slid onto a paint roller. The container is comprised of a resiliently deformable material wherein the container may be compressed onto the paint roller when the container is slid onto the paint roller. A plurality of ribs is attached to the container wherein each of the ribs engages the paint roller when the container is compressed onto the paint roller. Thus, the paint roller may be removed from a paint roller handle.

### BACKGROUND OF THE DISCLOSURE

### Field of the Disclosure

The disclosure relates to container devices and more particularly pertains to a new container device for removing a paint roller from a paint roller handle and storing the paint roller.

### SUMMARY OF THE DISCLOSURE

An embodiment of the disclosure meets the needs presented above by generally comprising a container that may be slid onto a paint roller. The container is comprised of a resiliently deformable material wherein the container may be compressed onto the paint roller when the container is slid onto the paint roller. A plurality of ribs is attached to the container wherein each of the ribs engages the paint roller when the container is compressed onto the paint roller. Thus, the paint roller may be removed from a paint roller handle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a container assembly according to an embodiment of the disclosure.

FIG. 2 is a right side view of an embodiment of the disclosure.

FIG. 3 is a cross sectional view taken along line 3-3 of FIG. 2 of an embodiment of the disclosure.

FIG. 4 is a cross sectional view taken along line 4-4 of FIG. 1 of an embodiment of the disclosure.

FIG. 5 is a perspective in-use view of an embodiment of the disclosure.

### DESCRIPTION OF THE PREFERRED EMBODIMENT

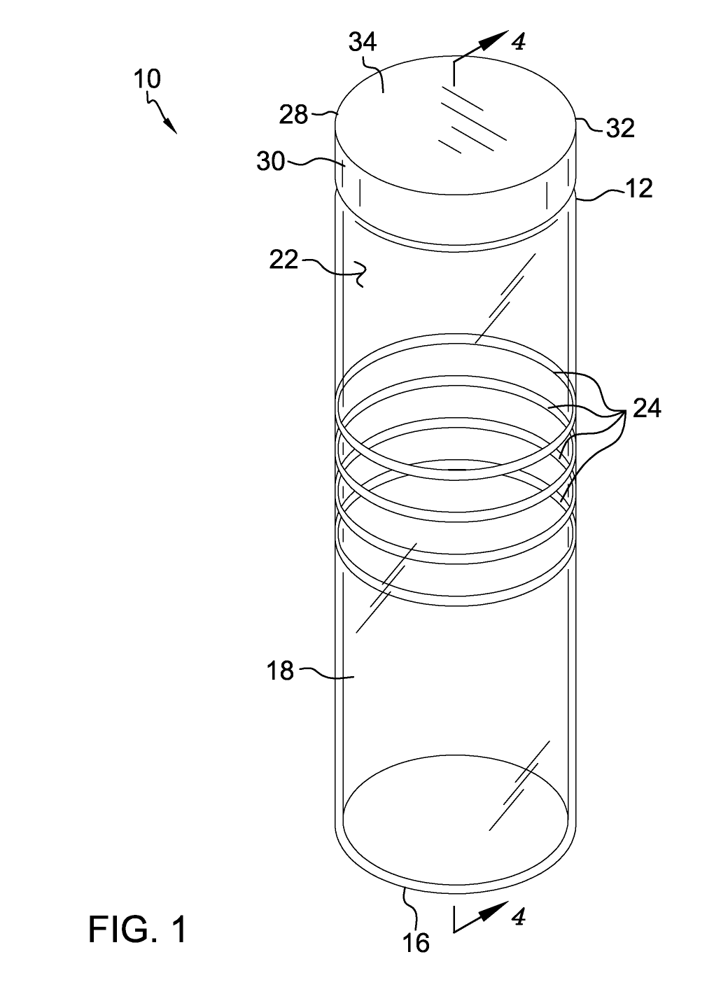

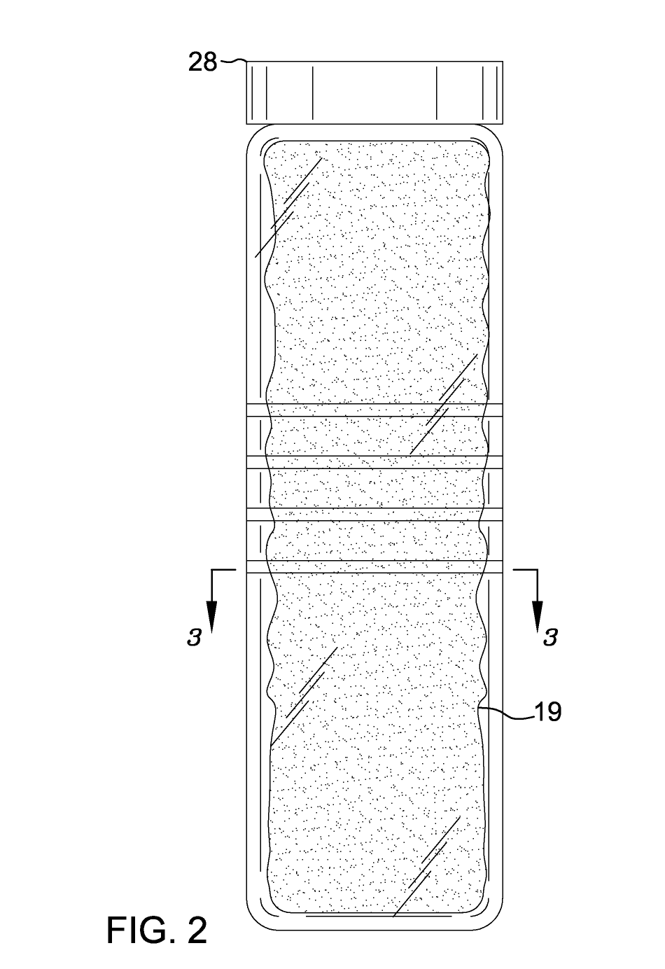

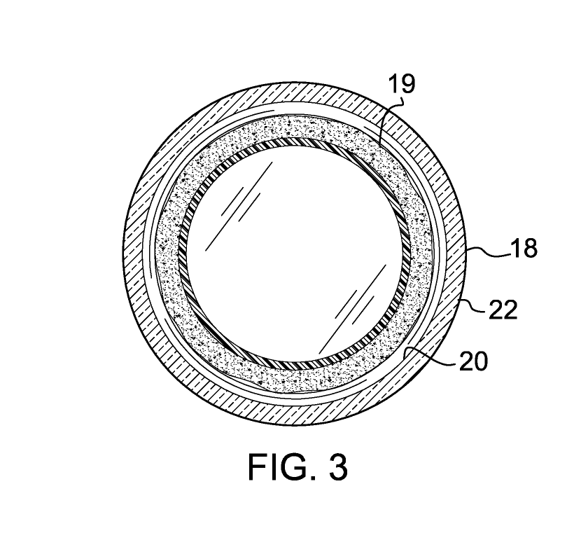

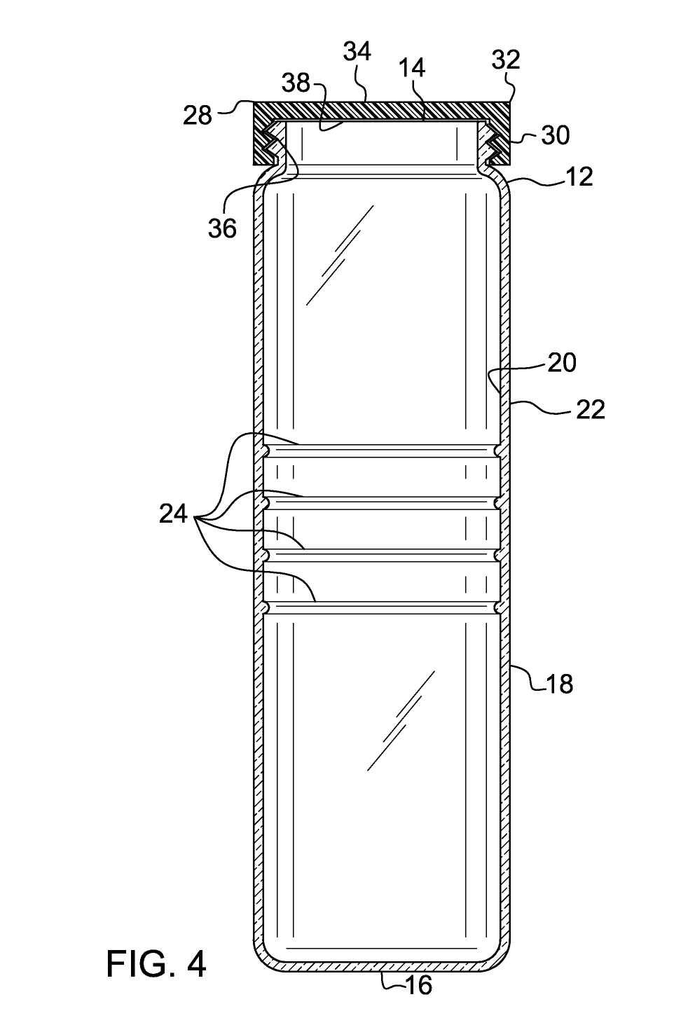

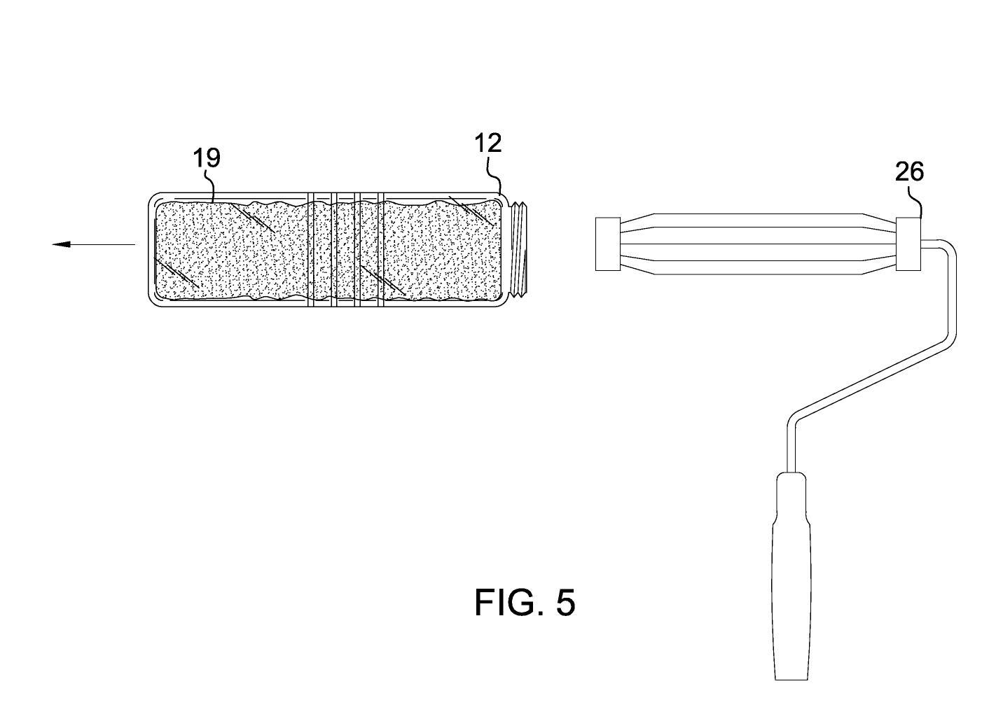

With reference now to the drawings, and in particular to FIGS. 1 through 5 thereof, a new container device embodying the principles and concepts of an embodiment of the disclosure and generally designated by the reference numeral 10 will be described.

As best illustrated in FIGS. 1 through 5, the container assembly 10 generally comprises a container 12 that has a top end 14, a bottom end 16 and a peripheral wall 18 extending between the top end 14 and the bottom end 16. The top end 14 is open wherein the container 12 may be slid onto a paint roller 19. The paint roller 19 may be a paint roller 19 of any conventional design.

The container 12 is substantially hollow and the peripheral wall 18 has an inside surface 20 and an outside surface 22. The peripheral wall 18 is continuous such that the container 12 has a cylindrical shape. The peripheral wall 18 is comprised of a resiliently deformable and translucent material wherein the container 12 may be compressed onto the paint roller 19 when the container 12 is slid onto the paint roller 19. The outside surface 22 of the peripheral wall 18 is threaded adjacent to the top end 14.

A plurality of ribs 24 is provided and each of the ribs 24 is attached to and extends inwardly from the inside surface 20 of the peripheral wall 18. The ribs 24 are spaced apart from each other and each of the ribs 24 is comprised of a resiliently deformable material. Each of the ribs 24 is centrally positioned within the container 12 wherein each of the ribs 24 may engage the paint roller 19 when the container 12 is compressed onto the paint roller 19. Thus, the paint roller 19 may be gripped to be removed from a paint roller handle 26 and the paint roller handle 26 may be a paint roller handle of any conventional design.

A cap 28 is provided that has a perimeter wall 30 coupled to and extending downwardly from an exterior edge 32 of a top wall 34. The perimeter wall 30 has an innermost surface 36 and the top wall 34 has a bottom surface 38. The innermost surface 36 threadably engages the outside surface 22 of the container 12 having the bottom surface 38 abutting the top end 14. The bottom surface 38 forms a fluid impermeable seal with respect to the top end 14. Thus, the cap 28 prevents the paint roller 19 from drying when the paint roller 19 is positioned within the container 12.

In use, the container 12 is slid onto the paint roller 19 after the paint roller 19 has been utilized in the convention of painting. The peripheral wall 18 of the container 12 is compressed such that the ribs 24 frictionally engage the paint roller 19. The container 12 is drawn away from the paint roller handle 26 thereby facilitating the paint roller 19 to be removed from the paint roller handle 26. The cap 28 is threaded onto the container 12 when the paint roller 19 is removed from the paint roller handle 26. The cap 28 is removed from the container 12 and the container 12 is manipulated to place the paint roller 19 onto the paint roller handle 26 when the paint roller 19 is to be utilized for painting. The container 12 facilitates a user to avoid contact with the paint roller 19.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

I claim:

1. A container assembly configured to contain a paint roller, said assembly comprising:
a container being configured to be slid onto a paint roller, said container being comprised of a resiliently deformable material wherein said container is configured to be compressed onto the paint roller when said container is slid onto the paint roller; and
a plurality of ribs, each of said ribs being attached to said container wherein each of said ribs is configured to engage the paint roller when said container is compressed onto the paint roller thereby facilitating the paint roller to be removed from a paint roller handle.

2. The assembly according to claim 1, wherein said container has a top end a bottom end and a peripheral wall extending between said top end and said bottom end, said top end being open, said container being substantially hollow, said peripheral wall having an inside surface and an outside surface, said peripheral wall being continuous such that said container has a cylindrical shape, said outside surface being threaded adjacent to said top end.

3. The assembly according to claim 2, wherein each of said ribs is attached to and extending inwardly from said inside surface, said ribs being spaced apart from each other, each of said ribs being centrally positioned within said container.

4. The assembly according to claim 1, further comprising a cap having a perimeter wall coupled to and extending downwardly from an exterior edge of a top wall, said perimeter wall having an innermost surface, said top wall having a bottom surface.

5. The assembly according to claim 4, wherein:
said container has an outside surface and a top end; and
said innermost surface threadably engaging said outside surface of said container having said bottom surface abutting said top end, said bottom surface forming a fluid impermeable seal with respect to said top end wherein said cap is configured to prevent the paint roller from drying when the paint roller is positioned within said container.

6. A container assembly configured to contain a paint roller, said assembly comprising:
a container having a top end a bottom end and a peripheral wall extending between said top end and said bottom end, said top end being open wherein said container is configured to be slid onto a paint roller, said container being substantially hollow, said peripheral wall having an inside surface and an outside surface, said peripheral wall being continuous such that said container has a cylindrical shape, said peripheral wall being comprised of a resiliently deformable material wherein said container is configured to be compressed onto the paint roller when said container is slid onto the paint roller, said outside surface being threaded adjacent to said top end;
a plurality of ribs, each of said ribs being attached to and extending inwardly from said inside surface, said ribs being spaced apart from each other, each of said ribs being centrally positioned within said container wherein each of said ribs is configured to engage the paint roller when said container is compressed onto the paint roller thereby facilitating the paint roller to be removed from a paint roller handle; and
a cap having a perimeter wall coupled to and extending downwardly from an exterior edge of a top wall, said perimeter wall having an innermost surface, said top wall having a bottom surface, said innermost surface threadably engaging said outside surface of said container having said bottom surface abutting said top end, said bottom surface forming a fluid impermeable seal with respect to said top end wherein said cap is configured to prevent the paint roller from drying when the paint roller is positioned within said container.
